(19) United States
(12) Patent Application Publication
(10) Pub. No.: US 2023/0214261 A1
(43) Pub. Date: Jul. 6, 2023

(54) COMPUTING POWER SHARING-RELATED EXCEPTION REPORTING AND HANDLING METHODS AND DEVICES, STORAGE MEDIUM, AND TERMINAL APPARATUS

(71) Applicant: SPREADTRUM SEMICONDUCTOR (NANJING) CO., LTD., Nanjing, Jiangsu (CN)

(72) Inventors: Runquan MIAO, Shanghai (CN); Ming SUN, Shanghai (CN); Yingying LIU, Shanghai (CN)

(21) Appl. No.: 18/020,118

(22) PCT Filed: Aug. 5, 2021
(86) PCT No.: PCT/CN2021/110779

§ 371 Date: Feb. 7, 2023

(30) Foreign Application Priority Data
Aug. 7, 2020 (CN) 202010791528.0

(51) Int. Cl. G06F 9/48; G06F 9/50; G06F 11/30

(52) U.S. Cl. CPC G06F 9/4893; G06F 9/5088; G06F 11/3062; G06F 11/3006

(57) ABSTRACT

Provided are a method and an apparatus for reporting and handling an exception in computing power sharing, a storage medium, and a terminal device. The method for reporting an exception in computing power sharing includes: detecting a current hardware state and a current battery state; and reporting an exception to a network unit, in a case that the hardware state or the battery state reaches a preset exception threshold, or in a case that a change of the hardware state or a change of the battery state reaches a preset reporting threshold. The method for handling an exception in computing power sharing includes: receiving an exception reported from a cooperative computing terminal; determining a total workload assigned to the cooperative computing terminal and a remaining workload of the cooperative computing terminal; and determining, based on the exception and the remaining workload, to reassign the remaining workload or the total workload.

This application claims priority to Chinese Patent Application No. 202010791528.0, titled “COMPUTING POWER SHARING-RELATED EXCEPTION REPORTING AND HANDLING METHODS AND DEVICES, STORAGE MEDIUM, AND TERMINAL APPARATUS”, filed on Aug. 7, 2020 with the China National Intellectual Property Administration (CNIPA), which is incorporated herein by reference in its entirety.

### FIELD

The present disclosure relates to the field of communication technology, and in particular to a method and an apparatus for reporting an exception in computing power sharing, a method and an apparatus for handling an exception in computing power sharing, a storage medium, and a terminal device.

### BACKGROUND

In the future, terminals have excess computing capabilities. Therefore, the terminals may be able to participate in distributed computing through a wireless network.

However, most of the terminals participating in the distributed computing are not computing-dedicated terminals. Hence, high utilization of a central processing unit (CPU) or memory of the terminal, low battery of the terminal, and other exceptions may occur during a computing process due to network videos, games, or the like. The exceptions, if fails to be detected and handled in time, may result in interruption of the distributed computing.

### SUMMARY

A technical problem solved by the present disclosure is how to detect or handle an exception in computing power sharing, so as to ensure success of a distributed computing.

In order to solve the above technical problem, a method for reporting an exception in computing power sharing is provided according to embodiments of the present disclosure. The method includes: detecting a current hardware state and a current battery state; and reporting an exception to a network unit, in a case that the hardware state or the battery state reaches a preset exception threshold, or in a case that a change of the hardware state or a change of the battery state reaches a preset reporting threshold, where the network unit determines a total workload assigned to the cooperative computing terminal and a remaining workload of the cooperative computing terminal, and determines, based on the exception and the remaining workload, to reassign the remaining workload or the total workload.

In an embodiment, the reporting an exception to a network unit includes: reporting a type of the exception to the network unit, where the type of the exception is selected from a hardware exception and a battery exception.

In an embodiment, the reporting an exception to a network unit includes: reporting a detail of the exception to the network unit, where the detail of the exception is selected from the hardware state and the battery state.

In an embodiment, the reporting an exception to a network unit includes: reporting a cause of the exception to the network unit, where the cause of the exception is selected from a cause of a hardware exception and a cause of a battery exception.

In an embodiment, the hardware state includes at least one of a CPU utilization, an NPU utilization, a GPU utilization, or a memory utilization; and the battery state includes a battery level.

In order to solve the above technical problem, a method for handling an exception in computing power sharing is further provided according to embodiments of the present disclosure. The method is applied to a network unit, and the method includes: receiving an exception reported from a cooperative computing terminal, where the cooperative computing terminal detects a current hardware state and a current battery state, and reports the exception in a case that the hardware state or the battery state reaches a preset exception threshold; determining a total workload assigned to the cooperative computing terminal and a remaining workload of the cooperative computing terminal; and determining, based on the exception and the remaining workload, to reassign the remaining workload or the total workload.

In an embodiment, the determining, based on the exception and the remaining workload, to reassign the remaining workload or the total workload includes: assigning the remaining workload or the total workload to a first cooperative terminal other than the cooperative computing terminal, based on a computing power resource of the first cooperative terminal, where the first cooperative terminal and the cooperative computing terminal provide computing powers to a same computing-demanded terminal.

In an embodiment, the determining, based on the exception and the remaining workload, to reassign the remaining workload or the total workload includes: sending a cooperation query to a second cooperative terminal other than the cooperative computing terminal, where the cooperation query includes a request for reporting computing an available computing power; receiving a response to the cooperation query returned by the second cooperative terminal in response to the cooperation query, where the response to the cooperation query includes information of the available computing power; and authorizing the second cooperative terminal to provide the computing power, in a case that the available computing power meets a computing power demand determined based on the remaining workload or the total workload.

In an embodiment, the method further includes: informing the computing-demanded terminal of a task failure, in a case that there is no cooperative terminal other than the cooperative computing terminal that is capable of providing a computing power or completing the remaining workload.

In an embodiment, the determining, based on the exception and the remaining workload, to reassign the remaining workload or the total workload includes: determining a completion time which is set when assigning a workload to the cooperative computing terminal, and determining a delayed time based on the completion time and a preset delay ratio; determining a current computing resource of the cooperative computing terminal based on the exception; determining whether the cooperative computing terminal is capable of completing the remaining workload within the delayed time by using the current computing resource; and determining, based on the exception and the remaining workload, to reassign the remaining workload or the total workload, in a case that the cooperative computing terminal is not capable of completing the remaining workload within the delayed time by using the current computing resource.

In an embodiment, the determining the remaining workload of the cooperative computing terminal includes: calculating the remaining workload based on a remaining overload percentage reported by the cooperative computing terminal and the total workload, where the remaining overload percentage is comprised in the exception reported by the cooperative computing terminal; or determining a first time instant when a workload is assigned to the cooperative computing terminal and a second time instant when the exception reported by the cooperative computing terminal is received, and estimating the remaining workload based on a time difference between the first time instant and the second time instant and the computing resource of the cooperative computing terminal.

In an embodiment, the determining, based on the exception and the remaining workload, to reassign the remaining workload or the total workload includes: determining a quantity of remaining samples based on a computing performance of the cooperative computing terminal and the remaining workload; and determining, based on the exception and the remaining workload, to reassign the quantity of remaining samples.

In an embodiment, the preset reporting threshold is less than the preset exception threshold, the exception includes current device information, and the current device information includes a current hardware state and a current battery state, and the determining, based on the exception and the remaining workload, to reassign the remaining workload or the total workload includes: determining whether a training result of the computing power sharing is converged; and determining, based on the exception and the remaining workload, to reassign the remaining workload or the total workload, in a case that the training result is not converged.

An apparatus for reporting an exception in computing power sharing is further disclosed according to embodiments of the present disclosure. The apparatus includes: a state detecting module, configured to detect a current hardware state and a current battery state; and an exception reporting module, configured to report an exception to a network unit, in a case that the hardware state or the battery state reaches a preset exception threshold, or in a case that a change of the hardware state or a change of the battery state reaches a preset reporting threshold, where the network unit determine a total workload assigned to the cooperative computing terminal and a remaining workload of the cooperative computing terminal, and determines, based on the exception and the remaining workload, to reassign the remaining workload or the total workload.

An apparatus for handling an exception in computing power sharing is further disclosed according to embodiments of the present disclosure. The apparatus includes: an exception receiving module, configured to receive an exception reported from a cooperative computing terminal, where the cooperative computing terminal detects a current hardware state and a current battery state, and reports the exception in a case that the hardware state or the battery state reaches a preset exception threshold; a task computing module, configured to determine a total workload assigned to the cooperative computing terminal and a remaining workload of the cooperative computing terminal; an assigning module, configured to determine, based on the exception and the remaining workload, to reassign the remaining workload or the total workload.

A storage medium is further disclosed according to embodiments of the present disclosure. The storage medium stores a computer program. The computer program, when executed on a processor, implements the method for reporting an exception in computing power sharing or the method for handling an exception in computing power sharing.

A terminal device is further disclosed according to embodiments of the present disclosure. The terminal device includes a memory and a processor. The memory stores a computer program executable on the processor. The computer program, when executed on the processor, configures the processor to perform the method for reporting an exception in computing power sharing or the method for handling an exception in computing power sharing.

Beneficial effects of the technical solutions of the embodiments of the present disclosure, compared with the conventional technology, are described below.

In the technical solutions of the present disclosure, the cooperative computing terminal detects the current hardware state and the current battery state, and reports an exception to the network unit in a case that the hardware state or the battery state reaches a preset exception threshold. In a process of providing a computing power sharing service according to the technical solutions of the present disclosure, the cooperative computing terminal can detect and report the exception timely by detecting the current hardware state and the current battery state. Hence, the network unit can know in time whether the cooperative computing terminal is capable of completing an assigned computing task on time. Thereby, the network unit can determine the remaining workload of the cooperative computing terminal, and determine, based on the exception and the remaining workload, to reassign the remaining workload or the total workload. Hence, a successful execution of a distributed computing task is ensured.

### BRIEF DESCRIPTION OF THE DRAWINGS

FIG. 1 is a flow chart of a method for reporting an exception in computing power sharing according to an embodiment of the present disclosure.

FIG. 2 is a flow chart of a method for handling an exception in computing power sharing according to an embodiment of the present disclosure.

FIG. 3 is a flow chart of a specific implementation of step S203 as shown in FIG. 2.

FIG. 4 is a flow chart of another specific implementation of step S203 as shown in FIG. 2.

FIG. 5 is a schematic diagram of an application scenario according to an embodiment of the present disclosure.

FIG. 6 is a schematic structural diagram of an apparatus for reporting an exception in computing power sharing according to an embodiment of the present disclosure.

FIG. 7 is a schematic structural diagram of an apparatus for handling an exception in computing power sharing according to an embodiment of the present disclosure.

### DETAILED DESCRIPTION OF EMBODIMENTS

As described in the background, most of terminals participating in a distributed computing are not computing-dedicated terminals. Hence, high utilization of a central processing unit (CPU) or memory of the terminal, low battery of the terminal, and other exceptions may occur during a computing process due to network videos, games, or the like. The exceptions, if fails to be detected and handled in time, may result in interruption of the distributed computing.

In a process of providing a computing power sharing service according to the technical solutions of the present disclosure, the cooperative computing terminal can detect and report the exception timely by detecting the current hardware state and the current battery state. Hence, the network unit can know in time whether the cooperative computing terminal is capable of completing an assigned computing task on time. Thereby, the network unit can determine the remaining workload of the cooperative computing terminal, and determine, based on the exception and the remaining workload, to reassign the remaining workload or the total workload. Hence, a successful execution of a distributed computing task is ensured.

In order to make the above objectives, features and advantages of the present disclosure more comprehensible, specific embodiments of the present disclosure are described in detail below in conjunction with the accompanying drawings.

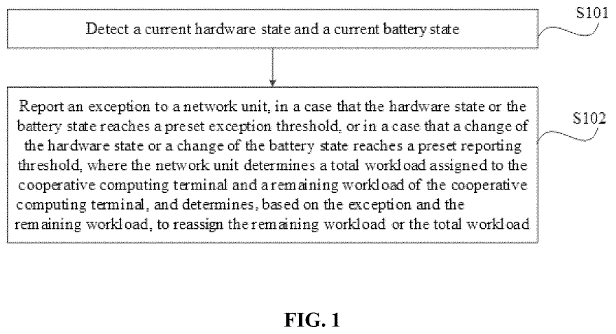

FIG. 1 is a method for reporting an exception in computing power sharing according to an embodiment of the present disclosure.

The method for reporting an exception in computing power sharing may be applied to a cooperative computing terminal in a computing power sharing system. The computing power sharing system may include a network unit, the cooperative computing terminal, and a computing-demanded terminal. The computing-demanded terminal refers to a terminal device or network device having a demand for distributed computing. The cooperative computing terminal refers to a terminal device or network device having surplus computing capabilities, and can provide a computing power. The network unit is configured to provide service for computing power sharing, that is, performing authorization and scheduling for the distributed computing. The network unit may be an original application function (AF) in a network architecture of the 3rd Generation Partnership Project (3GPP). Alternatively, a new network unit/function may be introduced to be responsible for the authorization, scheduling, and other functions for the distributed computing.

In an example, the network unit configured to provide a service for computing power sharing is specifically configured to perform the following aspects. The network unit sends a computing power query to a preset target, after receiving a computing power request from the cooperative computing terminal or the computing-demanded terminal, where the preset target includes one or both of the cooperative computing terminal and the computing-demanded terminal. The network unit receives a response from the preset target and provides service for computing power sharing based on the response, where the response includes a response to a computing power demand or a response to a computing power cooperation. The network unit receives a notification, where the notification includes a notification sent when the preset target determines that the service for the computing power sharing is completed.

Reference is made to FIG. 1. The method for reporting an exception in computing power sharing may specifically include steps S101 to S102.

In S101, a current hardware state and a current battery state are detected.

In S102, an exception is reported to a network unit, in a case that the hardware state or the battery state reaches a preset exception threshold, or in a case that a change of the hardware state or a change of the battery state reaches a preset reporting threshold. The network unit determines a total workload assigned to the cooperative computing terminal and a remaining workload of the cooperative computing terminal, and determines, based on the exception and the remaining workload, to reassign the remaining workload or the total workload.

It should be noted that serial numbers of the steps in the embodiments do not represent a limitation on a sequence of implementing the steps.

It can be understood that, in a specific embodiment, the method may be implemented in a form of a software program executing on a processor integrated in a chip or a chip module.

In this embodiment, the cooperative computing terminal can detect the current hardware state and the current battery state. The change of the hardware state refers to a variation from an initial hardware state to the current hardware state. The change of the battery state refers to a variation from an initial battery state to the current battery state. The initial hardware state is reported by the cooperative computing terminal in response to a cooperation query of the network unit. The initial battery state is reported by the cooperative computing terminal in response to a cooperation query of the network unit.

In a specific embodiment, the hardware state includes at least one of a CPU utilization, a graphics processing unit (GPU) utilization, a neural-network processing unit (NPU) utilization, or a memory utilization. The battery state includes a battery level.

Correspondingly, the preset exception threshold may include a first preset value corresponding to the CPU utilization, a second preset value corresponding to the GPU utilization, a third preset value corresponding to the memory utilization, or a fourth preset value corresponding to the battery level. The hardware state reaching the preset exception threshold may refer to at least one of the following: the CPU utilization reaching the first preset value, the GPU utilization reaching the second preset value, the memory utilization reaching the third preset value. The battery state reaching the preset exception threshold may refer to that the battery level t is less than the fourth preset value.

In other words, the exception may be reported in a case that one or more of the hardware state and battery state reaches the preset exception threshold. In an example, the exception may be reported in a case that at least one of the hardware state reaches the preset exception threshold.

It should be noted that a specific value of the preset exception threshold may be set based on an adaptability of the actual application environment, and the preset reporting threshold may include multiple threshold values for multiple hardware states and battery states, which are not limited in the embodiments of the present disclosure.

According to the embodiments of the present disclosure, a delay or failure in feeding back a local model by the cooperative computing terminal having an exception can be avoided. Thereby, affecting on an overall progress of the distributed computing or even a failure of the distributed computing can be avoided. Alternatively, the exception is reported in a case that the change reaches the preset reporting threshold. Thereby, the network unit can dynamically adjust a workload based on the latest device information, so that a probability of an occurrence of the exception in the computing power sharing is reduced.

In a non-limiting embodiment, S102 as shown in FIG. 1 may include a step of reporting a type of the exception to the network unit, where the type of the exception is selected from a hardware exception and a battery exception.

In this embodiment, the cooperative computing terminal may report a type of the exception when reporting the exception. For example, the cooperative computing terminal may report a hardware exception, or a battery exception, or both the hardware exception and the battery exception. In this way, the network unit can be aware of the type of the exception in the cooperative computing terminal, and process the exception correspondingly.

In another non-limiting embodiment, S102 as shown in FIG. 1 may include a step of reporting a detail of the exception to the network unit, where the detail of the exception is selected from the hardware state and the battery state.

In this embodiment, the cooperative computing terminal may report a detail of the exception when reporting the exception. For example, the cooperative computing terminal may report the hardware state, or the battery state, or both the hardware state and the battery state.

Furthermore, the cooperative computing terminal may report both the type of the exception and the detail of the exception. For example, the cooperative computing terminal may report that the type of the exception is a battery exception, and the detail of the exception is 20% power remained.

In a further non-limiting embodiment, S102 as shown in FIG. 1 may include a step of reporting a cause of the exception to the network unit, where the cause of the exception is selected from a cause of a hardware exception and a cause of a battery exception.

In this embodiment, the cooperative computing terminal may report a cause of the exception when reporting the exception.

Furthermore, the cooperative computing terminal may report the type of the exception, the detail of the exception, and the cause of the exception. For example, the cooperative computing terminal may report that: the type of the exception is a battery exception; the detail of the exception is 20% power remained; and the cause of the exception is online videos and games.

Reference is made to FIG. 2. The network unit may receive the exception reported by the cooperative computing terminal. That is, steps S201 to S203 may be implemented.

In S201, the exception reported from the cooperative computing terminal is received. Step S202 is to determine a total workload assigned to the cooperative computing terminal and a remaining workload of remaining tasks of the cooperative computing terminal.

In S202, a total workload assigned to the cooperative computing terminal and a remaining workload of the cooperative computing terminal are determined.

In S203, it is determined, based on the exception and the remaining workload, to reassign the remaining workload or the total workload.

In a specific implementation of S201, the network unit receives the exception reported from the cooperative computing terminal, and thereby knows that the cooperative computing terminal is in the exception and may be unable to complete the assigned workload on time. In this case, the network unit may perform S202 and S203, so as to determine whether the cooperative computing terminal can complete the total workload assigned to the cooperative computing terminal, that is, whether the cooperative computing terminal is able to complete the remaining workload. In a case that the cooperative computing terminal cannot complete the workload, the network unit needs to coordinate computing resources and reassign the remaining workload or the total workload, in order to ensure that the total workload can be completed in time to meet a computing demand of the computing-demanded terminal.

In the embodiment, the total workload may refer to the quantity of samples assigned to the cooperative computing terminal, and the remaining workload may refer to the quantity of to-be-trained samples at the cooperative computing terminal. For example, the quantity of samples assigned to the cooperative computing terminal is 16, and the cooperative computing terminal has a 4-core CPU. During a computing process, the cooperative computing terminal performs training on a set of 4 samples simultaneously. In a case that an exception occurs when a second set is half-completed, then the quantity of completed samples is calculated as (4+4*50%)=6, and the remaining workload is calculated as 16−6=10. Hence, a proportion of the remaining workload is calculated as 10/16=5/8.

In a specific implementation of S203, the network unit determines whether it is necessary to reassign the workload, and reassign the remaining workload or the total workload in determining that it is necessary to reassign the workload.

In a non-limiting embodiment, the S203 as shown in FIG. 2 may include the following steps: assigning the remaining workload or the total workload to a first cooperative terminal other than the cooperative computing terminal, based on a computing power resource of the first cooperative terminal. The first cooperative terminal and the cooperative computing terminal provide computing powers to a same computing-demanded terminal.

In an embodiment, multiple cooperative computing terminals may provide computing powers to a same computing-demanded terminal. In a case that one of the cooperative computing terminals fails to complete the assigned computing workload due to an exception, the network unit may assign the total workload assigned to the cooperative computing terminal to a first cooperative terminal other than this cooperative computing terminal, or may assign the remaining workload, that are not trained, to the first cooperation terminal. In the embodiments of the present disclosure, a successful completion of computing workloads from the computing-demand terminal cam ne ensured. The computing power resource of the first cooperative terminal may be reported in response to a cooperation query of the network unit (which may be also referred to as an available computing power). In a case that the available computing power of the first cooperative terminal meets a computing power demand determined based on the remaining workload or the total workload, the network unit may authorize the first cooperative terminal to provide the computing power, and assign the remaining workload or the total workload to the first cooperative terminal.

In an example, the quantity of first cooperative terminals may be one or more. An assignment of workloads to multiple first cooperative terminals may be based on computing power resources of the multiple first cooperative terminals. A first cooperative terminal whose computing resource has a greater computing power, for example, is assigned with more workloads.

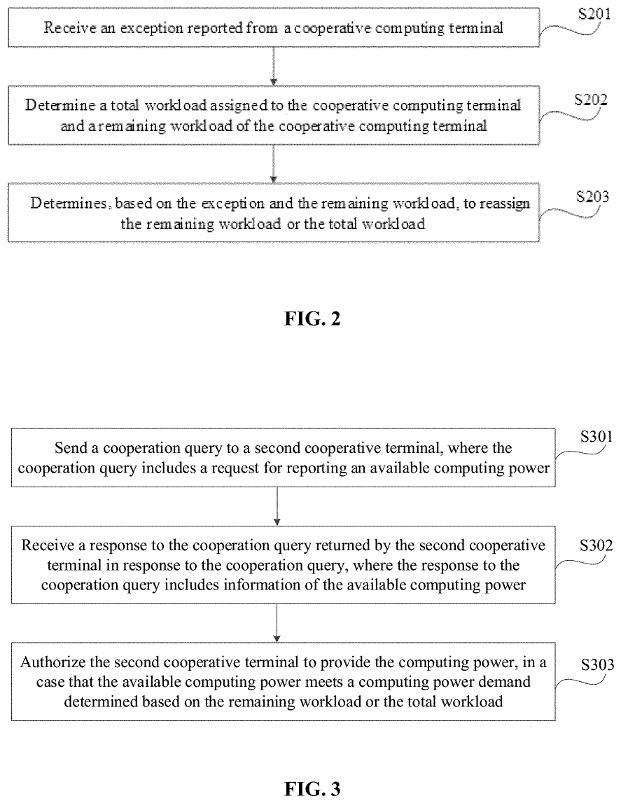

Reference is made to FIG. 3. In another non-limiting embodiment, S203 as shown in FIG. 2 may include the following steps S301 to S303.

In S301, a cooperation query is sent to a second cooperative terminal other than the cooperative computing terminal, where the cooperation query includes a request for reporting an available computing power.

In S302, a response to the cooperation query returned by the second cooperative terminal in response to the cooperation query is received, where the response to the cooperation query includes information of the available computing power.

In S303, the second cooperative terminal is authorized to provide the computing power, in a case that the available computing power meets a computing power demand determined based on the remaining workload or the total workload.

This embodiment may be implemented in a case that the network unit cannot find the first cooperative terminal that is capable of providing the computing power resource. In other words, in this case, the network unit needs to search for another available cooperative computing terminal to complete the total workload or remaining workload assigned to the cooperative computing terminal having the exception.

In an example, the network unit needs to send the cooperation query to at least one second cooperative terminal, in order to learn the available computing power of at least one second cooperative terminal. In a case that the available computing power can meet the computing power demand determined based on the remaining workload or the total workload, the second cooperative terminal is authorized to provide the computing power, that is, the second cooperative terminal executes the training of the total workload or the remaining workload.

Further, in a case that there is no other cooperative terminal (the first cooperative terminal or the second cooperative terminal) that can provide the computing power or perform the remaining workload, the computing-demanded terminal is informed of a task failure.

In an embodiment, in response to the task failure, the computing process of the computing-demanded terminal is terminated in advance, so as to save computing resources.

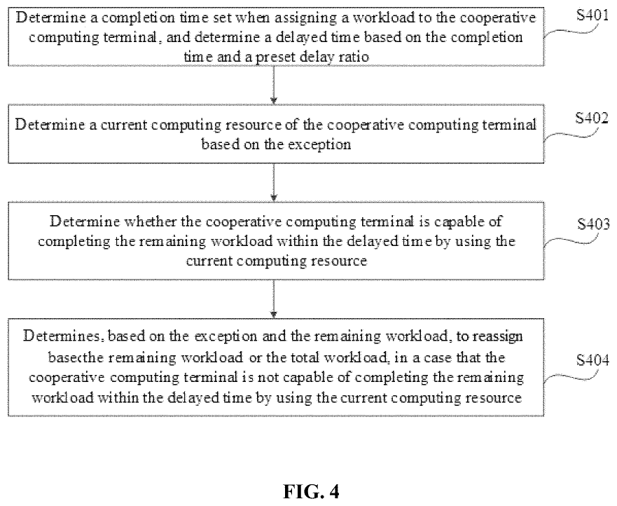

Reference is made to FIG. 4. In a non-limiting embodiment, the S203 as shown in FIG. 2 may include the following steps S401 to S404.

In S401, a completion time which is set when assigning a workload to the cooperative computing terminal is determined, and a delayed time is determined based on the completion time and a preset delay ratio.

In S402, a current computing resource of the cooperative computing terminal is determined based on the exception.

In S403, it is determined whether the cooperative computing terminal is capable of completing the remaining workload within the delayed time by using the current computing resources.

In S404, it is determined, based on the exception and the remaining workload, to reassign the remaining workload or the total workload, in a case that the cooperative computing terminal is not capable of completing the remaining workload within the delayed time by using the current computing resources.

In this embodiment, the network unit can determine whether the cooperative computing terminal having the exception is able to complete the remaining workload by using the current computing resources, that is, the current hardware state and/or battery state (such as the CPU/GPU/NPU/memory utilization, battery level, and the like).

In an example, a condition that the exception is acceptable may be comprehensively determined based on a type of the exception and a detail of the exception reported. A basic determination is whether the computation can be completed, under the exception, within a certain percentage (i.e., a preset delay ratio, such as 150%) of an original planned time (i.e., the completion time which is set when assigning a workload to the cooperative computing terminal) by using the current computing resource. In an example, the completion time set when assigning a workload to the cooperative computing terminal may be an average planned time for a single iteration. In a case that the completion time for a cooperative computing terminal is significantly different from others, a significant stagnation in the iteration may be caused.

It can be understood that the completion time may be set through any other practicable manners according to the conventional art, and the preset delay ratio may be set to different values based on requirements of the overall task on a computation time, both of which are not limited in the embodiments of the present disclosure.

In a non-limiting embodiment, S202 as shown in FIG. 2 may include steps of: calculating the remaining workload based on a remaining overload percentage reported by the cooperative computing terminal and the total workload, where the remaining overload percentage is included in the exception reported by the cooperative computing terminal; or determining a first time instant when a workload is assigned to the cooperative computing terminal and a second time instant when the exception reported by the cooperative computing terminal is received, and estimating the remaining workload based on a time difference between the first time instant and the second time instant and the computing resource of the cooperative computing terminal.

According to the embodiment of the present disclosure, the remaining workload of the cooperative computing terminal having the exception may be calculated.

In a specific implementation, the remaining workload percentage is reported when the cooperative computing terminal reporting the exception. The network unit calculates the remaining workload accurately based on the percentage and the total workload previously assigned. Alternatively, the network unit estimates a completed workload and the remaining workload based on a difference between the time instant when the workload is assigned and the time instant when the exception is reported, in combination with a previously obtained hardware performance (that is, a CPU/GPU/NPU/memory, a battery level, or other computing resources) of the cooperative computing terminal.

In a non-limiting embodiment, the S203 as shown in FIG. 2 may include steps of: determining a quantity of remaining samples based on a computing performance of the cooperative computing terminal and the remaining workload; and determining, based on the exception and the remaining workload, to reassign the quantity of remaining samples.

In this embodiment, the remaining workload and the quantity of remaining samples may be determined. The remaining workload may be used to estimate whether the cooperative computing terminal having the exception can successfully complete the workload. The quantity of remaining samples may be used for reassigning the workload.

In a specific implementation, a proportion of trained samples may be reported by the cooperative computing terminal when reporting the exception. The cooperative computing terminal basically performs training in sequence. To-be-trained samples may be determined based on the proportion of trained samples. In this case, the network unit needs to simply reassign the remaining samples (i.e., the to-be-trained samples). For example, the quantity of samples assigned to the cooperative computing terminal is 16, and the cooperative computing terminal has a 4-core CPU. During a computing process, the cooperative computing terminal performs training on a set of 4 samples simultaneously. In a case that an exception occurs when a second set is half-completed, the quantity of completed tasks is calculated as (4+4*50%)=6, and the remaining workload is calculated as 16−6=10. Hence, a proportion of remaining workload is calculated as 10/16=5/8. In a case that the quantity of completed samples is 4, a proportion of completed samples is calculated as 4/16=1/4, and the proportion of remaining samples is 3/4.

In another example, the network unit may assign the total workload. For example, 8 samples are assigned to the cooperative computing terminal, and the cooperative computing terminal has an 8-core CPU. The 8 samples are trained in parallel. In a case that an exception occurs when the training proceeds to 50%, although the remaining workload is only 50%, none of the samples is trained completely. In this case, the network unit has to reassign all the 8 samples, since a half-computed sample cannot be shared with the network or other cooperators.

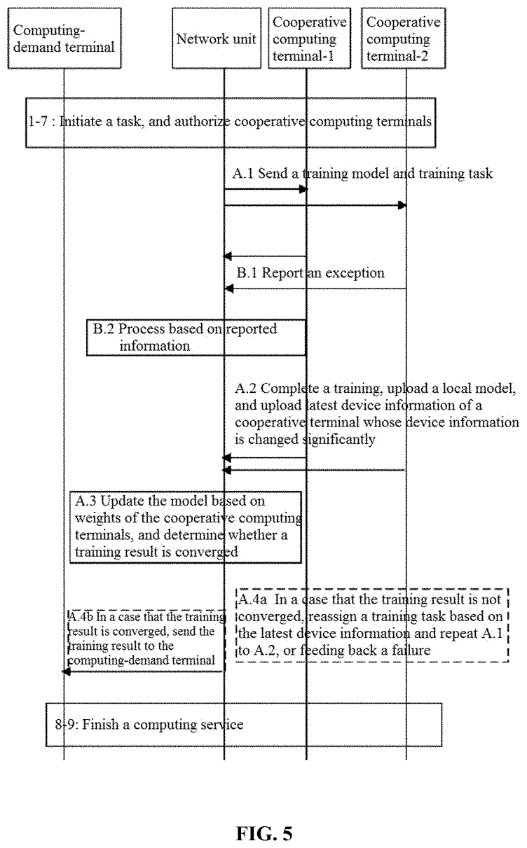

Reference is made to FIG. 5. In a specific application scenario, a network unit initiates a task and authorizes cooperative computing terminals in step 1-7.

In step A.1, the network unit sends a training model and a training task to the authorized cooperative computing terminals. The training task includes a total workload.

In step B.1, cooperative computing terminal-2 reports an exception. The exception is reported when a hardware state or battery state of the cooperative computing terminal-2 reaches a preset exception threshold.

In step B.2, the network unit processes based on the reported information. For example, the network may determine, based on an exception detail and a remaining workload, to reassign the remaining workload or the total workload. Specifically, step 1-7 may be re-executed to initiate a task and authorize cooperative computing terminals.

In step A.2, the cooperative computing terminals complete trainings and upload local models; and a cooperative terminal whose device information is changed significantly needs to further upload the latest device information. The device information may be a hardware state or a battery state. In this case, a change of the hardware state or a change of the battery state of the cooperative computing terminal-2 reaches a preset reporting threshold.

In step A.3, the network unit updates the model based on weights of the cooperative computing terminals, and determines whether a training result is converged.

In step A.4a, in a case that the training result is not converged, the network unit reassigns the training task based on the latest device information, and repeat steps A.1 to A.2 or feeds back a failure.

In step A.4b, in a case that the training result is converged, the network unit sends the training result to the computing-demanded terminal.

In steps 8-9, the computing service ends.

In this embodiment, after a round of computation is completed, if the device information of some of the cooperative computing terminals is changed significantly, the latest device information is to be reported, even if the preset exception threshold is not reached. The latest device information includes a CPU/GPU/memory utilization, a battery level, and the like. The cooperative computing terminal may further report a cause for the significant change of the device information.

In a case that the network unit, which is in charge of authorization and scheduling, determines that a computing result is not converged, workload is assigned based on the latest device information and remaining computing tasks. In a case that current computing powers of all the cooperative terminals cannot complete the remaining computing tasks, other available cooperative computing terminals may be searched for, and the remaining workload or the total workload is reassigned to the other available cooperative computing terminals. In a case that no suitable computing cooperator is found, the computation fails and the computation process is terminated in advance.

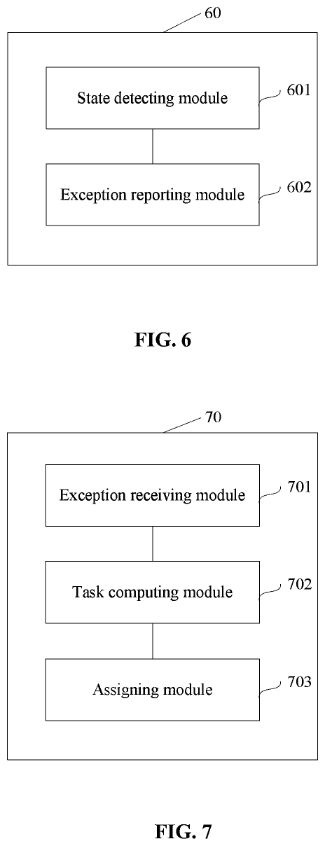

Reference is made to FIG. 6. An apparatus 60 for reporting an exception in computing power sharing is further disclosed according to an embodiment of the present disclosure. The apparatus 60 may include a state detecting module 601 and an exception reporting module 602.

The state detecting module 601 is configured to detect a current hardware state and a current battery state. The exception reporting module 602 is configured to report an exception to a network unit, in a case that the hardware state or the battery state reaches a preset exception threshold, or in a case that a change of the hardware state or a change of the battery state reaches a preset reporting threshold. Thereby, the network unit determines a total workload assigned to the cooperative computing terminal and a remaining workload of the cooperative computing terminal; and determines, based on the exception and the remaining workload, to reassign the remaining workload or the total workload.

More details of principles and operations of the apparatus 60 may refer to related descriptions for FIG. 1 to FIG. 5, which are not repeated here.

Reference is made to FIG. 7. An apparatus 70 for handling an exception in computing power sharing is further disclosed according to an embodiment of the present disclosure. The apparatus 70 may include an exception receiving module 701, a workload computing module 702, and an assigning module 703.

The exception receiving module 701 is configured to receive an exception reported from a cooperative computing terminal. The cooperative computing terminal detects a current hardware state and a current battery state, and reports the exception in a case that the hardware state or the battery state reaches a preset exception threshold. The workload computing module 702 is configured to determine a total workload assigned to the cooperative computing terminal and a remaining workload of the cooperative computing terminal. The assigning module 703 is configured to determine, based on the exception and the remaining workload, to reassign the remaining workload or the total workload.

More details of principles and operations of the apparatus 70 may refer to the related descriptions for FIG. 1 to FIG. 5, which are not repeated here.

The modules/units of each device and product described in the above embodiments may be software modules/units or hardware modules/units, or partially be software modules/units and partially be hardware modules/units. For example, for each device or product applied to or integrated into a chip, each module/unit included therein may be realized through circuits or other hardware; or at least some of the modules/units may be realized through software programs running on a processor integrated inside the chip, and the remaining (if any) modules/units may be realized through circuits or other hardware. For each device or product applied to or integrated into a chip module, each module/unit included therein may be realized through circuits or other hardware. Different modules/units may be disposed in a same component (such as a chip, a circuit module, or the like) or different components of the chip module; or at least some of the modules/units may be realized through software programs running on a processor integrated inside the chip module, and the remaining (if any) modules/units may be realized through circuits or other hardware. For each device or product applied to or integrated in a terminal, each module/unit may be realized through circuits or other hardware. Different modules/units may be disposed in a same component (such as a chip, a circuit module, or the like) or different components in the terminal; or at least some of the modules/units may be realized through software programs running on a processor integrated inside the terminal, and the remaining (if any) modules/units may be realized through circuits or other hardware.

A storage medium is further disclosed according to an embodiment of the present disclosure. The storage medium is a computer-readable storage medium storing a computer program. The computer program, when executed, implements the methods as shown in FIG. 1 to FIG. 5. The storage medium may include an ROM, an RAM, a magnetic disk, an optical disk, or the like. The storage medium may further include a non-volatile memory, a non-transitory memory, or the like.

Further, a terminal device is further disclosed according to an embodiment of the present disclosure. The terminal device may include a memory and a processor. The memory stores a computer program executable on the processor. The computer program, when executed on the processor, configures the processor to perform the method as shown in FIG. 1 to FIG. 5. The terminal device includes, but is not limited to, mobile phones, computers, tablet computers, and other terminal devices.

Although the present disclosure is disclosed as above, the present disclosure is not limited thereto. Various changes and modifications can be made by those skilled in the art without departing away from the spirit and scope of the present disclosure. Therefore, the protection scope of the present disclosure should be determined based on the scope defined by the claim.

1. A method for reporting an exception in computing power sharing, applied to a cooperative computing terminal, wherein the method comprises:
detecting a current hardware state and a current battery state; and
reporting an exception to a network unit, in a case that the hardware state or the battery state reaches a preset exception threshold, or in a case that a change of the hardware state or a change of the battery state reaches a preset reporting threshold,
wherein the network unit
determines a total workload assigned to the cooperative computing terminal and a remaining workload of the cooperative computing terminal, and
determines, based on the exception and the remaining workload, to reassign the remaining workload or the total workload.

2. The method according to claim 1, wherein the reporting an exception to a network unit comprises:
reporting a type of the exception to the network unit, wherein the type of the exception is selected from a hardware exception and a battery exception.

3. The method according to claim 1, wherein the reporting an exception to a network unit comprises:
reporting a detail of the exception to the network unit, wherein the detail of the exception is selected from the hardware state and the battery state.

4. The method according to claim 1, wherein the reporting an exception to a network unit comprises:
reporting a cause of the exception to the network unit, wherein the cause of the exception is selected from a cause of a hardware exception and a cause of a battery exception.

5. The method according to claim 1, wherein
the hardware state comprises at least one of a CPU utilization, an NPU utilization, a GPU utilization, or a memory utilization, and
the battery state comprises a battery level.

6. (canceled)

7. (canceled)

8. (canceled)

9. (canceled)

10. (canceled)

11. (canceled)

12. (canceled)

13. (canceled)

14. (canceled)

15. (canceled)

16. A non-transitory storage medium storing a computer program, wherein
the computer program, when executed on a processor, is configured to:
detect a current hardware state and a current battery state, and
report an exception to a network unit, in a case that the hardware state or the battery state reaches a preset exception threshold, or in a case that a change of the hardware state or a change of the battery state reaches a preset reporting threshold,
wherein the network unit
determines a total workload assigned to the cooperative computing terminal and a remaining workload of the cooperative computing terminal, and
determines, based on the exception and the remaining workload, to reassign the remaining workload or the total workload.

17. A terminal device, comprising a memory and a processor, wherein
the memory stores a computer program executable on the processor, and
the computer program, when executed on the processor, configures the processor to:
detect a current hardware state and a current battery state, and
report an exception to a network unit, in a case that the hardware state or the battery state reaches a preset exception threshold, or in a case that a change of the hardware state or a change of the battery state reaches a preset reporting threshold,
wherein the network unit
determines a total workload assigned to the cooperative computing terminal and a remaining workload of the cooperative computing terminal, and
determines, based on the exception and the remaining workload, to reassign the remaining workload or the total workload.

18. The non-transitory storage medium according to 16, wherein the computer program, when executed on a processor, is specifically configured to:
report a type of the exception to the network unit, wherein the type of the exception is selected from a hardware exception and a battery exception.

19. The non-transitory storage medium according to 16, wherein the computer program, when executed on a processor, is specifically configured to:
report a detail of the exception to the network unit, wherein the detail of the exception is selected from the hardware state and the battery state.

20. The non-transitory storage medium according to 16, wherein the computer program, when executed on a processor, is specifically configured to:
report a cause of the exception to the network unit, wherein the cause of the exception is selected from a cause of a hardware exception and a cause of a battery exception.

21. The non-transitory storage medium according to 16, wherein
the hardware state comprises at least one of a CPU utilization, an NPU utilization, a GPU utilization, or a memory utilization, and
the battery state comprises a battery level.

22. The terminal device according to claim 17, wherein the processor is specifically configured to:
report a type of the exception to the network unit, wherein the type of the exception is selected from a hardware exception and a battery exception.

23. The terminal device according to claim 17, wherein the processor is specifically configured to:
report a detail of the exception to the network unit, wherein the detail of the exception is selected from the hardware state and the battery state.

24. The terminal device according to claim 17, wherein the processor is specifically configured to:
report a cause of the exception to the network unit, wherein the cause of the exception is selected from a cause of a hardware exception and a cause of a battery exception.

25. The terminal device according to claim 17, wherein
the hardware state comprises at least one of a CPU utilization, an NPU utilization, a GPU utilization, or a memory utilization, and
the battery state comprises a battery level.
